(19) United States
(12) Patent Application Publication
(10) Pub. No.: US 2006/0198948 A1
(43) Pub. Date: Sep. 7, 2006

(54) Method of coating electric wire and insulated wire

(76) Inventors: Toshitaka Kawanami, Osaka (JP); Hiroyuki Sakamoto, Osaka (JP); Hidenori Tanaka, Osaka (JP); Kazuo Morichika, Osaka (JP); Takao Saito, Osaka (JP)

Correspondence Address: JORDAN AND HAMBURG LLP, 122 EAST 42ND STREET, SUITE 4000, NEW YORK, NY, 10168, US

(21) Appl. No.: 10/555,566

(22) PCT Filed: May 12, 2004
(86) PCT No.: PCT/JP04/06692

§ 371 Date: Feb. 2, 2006

(30) Foreign Application Priority Data
May 12, 2003 (JP) 2003-133716
May 12, 2003 (JP) 2003-133717

(51) Int. Cl. B05D 5/12

(52) U.S. Cl. 427/118

(57) ABSTRACT

It is an object of the present invention to provide a method of coating an electric wire by which an insulated wire having a high dielectric breakdown voltage can be obtained. A method of coating an electric wire, comprising a step (I) of forming a first insulating film by cationic electrode-position using a cationic electrocoating, and a step (I I) of forming a second insulating film on the first insulating film formed in the step (I) using an insulating coating, said cationic electrocoating containing a resin composition of which a hydratable functional group is reduced directly by an electron and passivated, resulting in deposition of a film

### TECHNICAL FIELD

The present invention relates to a method of coating an electric wire and an insulated wire.

### BACKGROUND ART

Insulated wires have been in wide use in the application areas such as electric and electronic equipment. These insulated wires generally have a structure in that an insulating film for protection and an enamel wire obtained by coating and baking an insulating coating containing organic resins such as various synthetic resins or natural resins is widely used.

As an insulating coating, insulating coatings formed by containing polyvinyl formal resin, polyurethane resin, polyester resin, polyester-imide resin, polyamide-imide resin, polyimide resin, polyamide resin or epoxy resin are generally used widely. In addition, preparation of an insulated wire is widely performed by elecrodeposition using elecrocoatings which have been previously used widely (see, for example, Japanese Kokai Publication Sho-48-49826 and Japanese Kokai Publication Hei-3-159014).

However, as an amount of an electric current or voltage to be passed through an electric wire and a voltage grow large, insulation breakdown occurs due to slight coating defect and, as a result, an insulated wire having the sufficient insulating property may not be obtained in some cases.

Therefore, there has been desired development of a coating method by which an insulated wire having resistance to large electric current and high voltage and having the high insulating property can be obtained.

Further, in order to increase an occupancy rate of an insulated wire or improve the function of an electric wire, an electric wire having edges such as a shaped wire has been developed, and an insulated wire formed by using this wire as an article to be coated, has been developed.

However, when a wire having edges is treated utilizing the above insulating coating and electrocoating which have been previously used widely, the film thickness of an insulating film formed on the edge becomes thin, as a result, an insulated wire having the sufficient insulating property may not be obtained in some cases.

Therefore, there has been desired development of a coating method which can form an insulating film also on the edge with a sufficient film thickness and by which an insulated wire having the high insulating property can be obtained.

### SUMMARY OF THE INVENTION

In view of the above-mentioned circumstances, it is an object of the present invention to provide a method of coating an electric wire by which an insulated wire having a high dielectric breakdown voltage can be obtained.

The present invention is a method of coating an electric wire, comprising a step (I) of forming a first insulating film by cationic electrodeposition using a cationic electrocoating, and a step (II) of forming a second insulating film on the first insulating film formed in the step (I) using an insulating coating,

said cationic electrocoating containing a resin composition of which a hydratable functional group is reduced directly by an electron and passivated, resulting in deposition of a film.

Preferably, the resin composition has a sulfonium group and a propargyl group.

Preferably, the resin composition has a sulfonium group content of 5 to 400 milli moles, a propargyl group content of 10 to 495 milli moles and a total content of the sulfonium and propargyl groups of 500 milli moles or less, per 100 g of the solid matter in the resin composition.

Preferably, the resin composition has a sulfonium group content of 5 to 250 milli moles, a propargyl group content of 20 to 395 milli moles and a total content of the sulfonium and propargyl groups of 400 milli moles or less, per 100 g of the solid matter in the resin composition.

Preferably, the resin composition has an epoxy resin as a skeleton.

Preferably, the epoxy resin is a novolak cresol epoxy resin or a novolak phenol epoxy resin, and has a number-average molecular weight of 700 to 5000.

The present invention is also an insulated wire, which is obtained by method of coating an electric wire.

The present invention is also a method of coating an electric wire having edges comprising a step (I) of forming a first insulating film by cationic electrodeposition using a cationic electrocoating, and a step (II) of forming a second insulating film on the first insulating film formed in the step (I) using an insulating coating,

said cationic electrocoating containing a resin composition of which a hydratable functional group is reduced directly by an electron and passivated, resulting in deposition of a film and

the cationic electrocoating and/or the insulating coating containing crosslinked resin particles.

Preferably, the cationic electrocoating contains crosslinked resin particles.

Preferably, the crosslinked resin particle is one of which a hydratable functional group is reduced directly by electrons and passivated.

Preferably, the content of the crosslinked resin particles is 0.5 to 40% by weight in the coating.

Preferably, the crosslinked resin particle is obtained by emulsion polymerizing an α,β-ethylenically unsaturated monomer mixture using a resin having an onium group as an emulsifier.

Preferably, the resin having an onium group has 2 to 15 onium groups per one molecule.

Preferably, the emulsifier is an acrylic resin or an epoxy resin.

Preferably, the onium group is an ammonium group or a sulfonium group.

Preferably, the acrylic resin or the epoxy resin, having the ammonium group or the sulfonium group, is obtained by adding a tertiary amine compound or sulfide and an organic acid to an acrylic resin or an epoxy resin, having an epoxy group, to convert the acrylic resin or the epoxy resin to a quaternary ammonium compound or a tertiary sulfonium compound.

Preferably, a number-average molecular weight of the acrylic resin or the epoxy resin, having an epoxy group, is 2000 to 20000.

Preferably, the resin composition has a sulfonium group and a propargyl group.

Preferably, the resin composition has a sulfonium group content of 5 to 400 milli moles, a propargyl group content of 10 to 495 milli moles and a total content of the sulfonium and propargyl groups of 500 milli moles or less, per 100 g of the solid matter in the resin composition.

Preferably, the resin composition includes an epoxy resin having a novolak cresol epoxy resin or a novolak phenol epoxy resin as a skeleton and having a number-average molecular weight of 700 to 5000, and

the resin composition also has a sulfonium group content of 5 to 250 milli moles, a propargyl group content of 20 to 395 milli moles and a total content of the sulfonium and propargyl groups of 400 milli moles or less, per 100 g of the solid matter in the resin composition.

The present invention is also an insulated wire, which is obtained by method of coating an electric wire having edges.

### BRIEF DESCRIPTION OF THE DRAWINGS

FIG. 1 shows an example of a schematic view of a cross section of an insulated wire obtained by the method of coating an electric wire having edges in accordance with the present invention; and

FIG. 2 shows an example of a schematic view of a cross section of an insulated wire obtained in the case of using no crosslinked resin particle.

### EXPLANATION OF THE NUMERICAL SYMBOLS

1 shaped wire
2 first insulating film
3 second insulating film
4 insulated wire
5 edge
6 insulated wire

### DETAILED DESCRIPTION OF THE INVENTION

The present invention will be described in detail below.

The method of coating an electric wire of the present invention comprises a step (I) of forming a first insulating film by cationic electrodeposition using a cationic electrocoating, and a step (II) of forming a second insulating film on the first insulating film formed in the step (I) using an insulating coating.

Since the method of coating an electric wire comprises the step (I) and the step (II), it is a method which can afford an insulated wire having a higher dielectric breakdown voltage as compared with an insulated wire obtained from the previous insulating coating.

That is, in the method of coating an electric wire of the present invention, by performing a step of forming a first insulating film having a high dielectric breakdown voltage by cationic electrodeposition using a cationic electrocoating containing a resin composition of which a hydratable functional group is reduced directly by an electron and passivated, resulting in deposition of a film, and further, a step of forming a second insulating film by coating an insulating coating formed by containing a polyvinyl formal resin, polyurethane resin, polyester resin, polyester-imide resin, polyamide-imide resin, polyimide resin, polyamide resin or epoxy resin on the first insulating film, a dielectric breakdown voltage is considerably enhanced as compared with each insulated wire obtained only by cationic electrodeposition using the cationic electrocoating, or only by coating the insulating coating.

The method of coating an electric wire of the present invention is characterized in that, before formation of a second insulating film using the previously used insulating coating, first, a first insulating film is formed using a particular cationic electrocoating in the step (I). That is, when an insulated wire is prepared using the previous insulating coating, it is difficult to obtain an insulated wire having a sufficient dielectric breakdown voltage. However, by performing the step (I) using the particular cationic electrocoating before coating of such the insulating coating, a dielectric breakdown voltage of the resulting insulated wire can be considerably improved. Therefore, an insulated wire obtained by the above method of coating an electric wire can be also suitably used in uses requiring a higher dielectric breakdown voltage.

In the process for obtaining an insulated wire by coating and curing the previous insulating coating, an insulated wire is prepared by repeating a cycle of coating and curing of an insulating coating usually around 7 to 15 times. Since the insulating property can be improved by repeating a cycle of coating and curing, it is necessary to repeat the cycle many times in order to obtain the desired insulating property. To the contrary, in the method of coating an electric wire of the present invention, by applying an insulating coating, preferably repeating a cycle of applying an insulating coating around several times after the step (I), an insulated wire having a high dielectric breakdown voltage can be obtained and, therefore, the number of steps can be reduced, and the manufacturing cost can be also reduced.

In the method of coating an electric wire of the present invention, first, a step (I) of forming a first insulating film is performed by cationic electrodeposition using a cationic electrocoating, and the cationic electrocoating used in the step (I) contains a resin composition of which a hydratable functional group is reduced directly by an electron and passivated, resulting in deposition of a film. By forming a first insulating film using the cationic electrocoating in the step (I), an insulated wire having a high dielectric breakdown voltage can be obtained.

The mechanism of deposition on the cathode as caused by voltage application in the step (I) is represented by the following formula (1), and the insulating film is passivated to be deposited by providing the hydratable functional group in the resin composition (substrate; expressed by “S” in the formula) with an electron on the cathode.

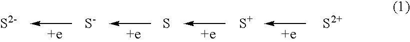

That is, when the reaction represented by the formula (1) occurs, the hydratable functional group existing in the resin composition in the cationic electrocoating is directly reduced on the cathode, resulting in insolubilization and deposition. Since the film deposited according to this mechanism has the higher dielectric breakdown voltage.

In the method of coating an electric wire of the present invention, the resin composition has preferably a sulfonium group and a propargyl group. By using a resin composition having a sulfonium group and a propargyl group, an insulated wire having a higher dielectric breakdown voltage can be obtained.

The resins composing the above resin composition may contain both a sulfonium group and a propargyl group in each molecule, but it does not necessarily do so. Thus, for example, the resins may have only either the sulfonium group or the propargyl group in each molecule. In the latter case, however, the whole resin composition has both of these two kinds of curable functional groups. That is, the above resin composition may comprise any resin containing sulfonium group and propargyl group, a mixture of a resin having only a sulfonium group(s) and a resin having only a propargyl group(s), or a mixture of all of these kinds of resins. It is herein defined in the above sense that the resin composition has both sulfonium and propargyl groups.

The sulfonium group is a hydratable functional group in the resin composition. When an electric voltage or current exceeding a certain level is applied to the sulfonium group in the electrodeposition step, the group is subjected to an electrolytic reduction on the electrode; thereby, the ionic group disappears and the sulfonium group can be irreversibly passivated.

It is considered that, in this electrodeposition step, the electrode reaction provoked generates the hydroxide ion, and the sulfonium group holds the hydroxide ion, with the result that an electrolytically generated base is formed in the electrodeposited film. This electrolytically generated base can convert the propargyl group existing in the electrodeposited film and being low in reactivity upon heating to the allene bond high in reactivity upon heating.

The resin to act as the skeleton of the above-mentioned resin composition is not particularly limited, but an epoxy resin is suitably used.

As the above-mentioned epoxy resin, there are suitably used those having at least two epoxy groups in a molecule, including, for example, polyepoxy resins such as epi-bis-epoxy resins; modifications thereof obtained by extending its chain with diol, dicarboxylic acid, diamine or the like; epoxidized polybutadiene; novolak phenol polyepoxy resins; novolak cresol polyepoxy resins; polyglycidyl acrylate; polyglycidyl ethers of aliphatic polyols or polyether polyol; and polyglycidyl esters of polybasic carboxylic acids. In particular, novolak phenol polyepoxy resins, novolak cresol polyepoxy resins and polyglycidyl acrylate are preferred because of the ease of polyfunctionalization for enhancing curability. In addition, part of the above-mentioned epoxy resin may be a monoepoxy resin.

Preferably, the resin composition includes a resin having the epoxy resin as a skeleton and has a number-average molecular weight of 500 (lower limit) to 20000 (upper limit). When it is less than 500, the coating efficiency in the electrodeposition step will be poor, and when it exceeds 20000, a good film cannot be formed on the surface of a substrate. As for the number-average molecular weight, a more preferable molecular weight can be selected in accordance with the resin skeleton. In the case of novolak phenol epoxy resins and novolak cresol epoxy resins, for example, the lower limit is preferably 700 and the upper limit is preferably 5000.

Preferably, the sulfonium group content in the resin composition is within a range of 5 milli moles (lower limit) to 400 milli moles (upper limit) per 100 g of the solid matter in the resin composition provided that the total content of the sulfonium and propargyl groups conditions to be mentioned later herein are satisfied. When this content is less than 5 milli moles per 100 g of the solid matter, curability cannot be adequately exerted, and hydratability and bath stability are deteriorated. When it exceeds 400 milli moles per 100 g of the solidmatter, the deposition of film on the surface of a substrate becomes poor. As for the sulfonium group content, a more preferable content can be selected in accordance with the resin skeleton employed. In the case of novolak phenol epoxy resins and novolak cresol epoxy resins, for example, the above lower limit is preferably 5 milli moles, more preferably 10 milli moles per 100 g of the solid matter in the resin composition. In addition, the above upper limit is preferably 250 milli moles, more preferably 150 milli moles per 100 g of the solid matter in the resin composition.

The propargyl group of the resin composition acts as a curable functional group in the cationic electrocoating.

Preferably, the propargyl group content in the resin composition is within a range of 10 milli moles (lower limit) to 495 milli moles (upper limit) per 100 g of the solid matter in the resin composition provided that the total content of the sulfonium and propargyl groups conditions to be mentioned later herein are satisfied. When this content is less than 10 milli moles per 100 g of the solid matter, curability cannot be sufficiently exerted, and when it exceeds 495 milli moles per 100 g of the solid matter, the hydration stability in the case of being used as an electrocoating may be affected. As for the propargyl group content, a more preferable content can be selected in accordance with the resin skeleton employed. In the case of novolak phenol epoxy resins and novolak cresol epoxy resins, for example, the above lower limit is more preferably 20 milli moles and the above upper limit is more preferably 395 milli moles, per 100 g of the solid matter in the resin composition.

The total content of the sulfonium and propargyl groups, in the above resin composition, is preferably 500 milli moles or less per 100 g of the solid matter in the resin composition. When this content exceeds 500 milli moles per 100 g of the solid matter, a resin may not be attained in fact or a desired performance may not be attained. As for the total content of the sulfonium and propargyl groups, in the above resin composition, a more preferable content can be selected in accordance with the resin skeleton employed. In the case of novolak phenol epoxy resins and novolak cresol epoxy resins, for example, the total content is more preferably 400 milli moles or less per 100 g of the solid matter in the resin composition.

Part of the propargyl group in the resin composition may be converted to an acetylide. An acetylide is a salt-like acetylated metal compound. As for the content of the propargyl group to be converted to an acetylide in the resin composition, preferably, the lower limit is 0.1 milli mole and the upper limit is 40 milli moles, per 100 g of the solid matter in the resin composition. When this content is less than 0.1 milli mole per 100 g of the solid matter, the effect of the conversion to an acetylide are not sufficiently exerted, and when it exceeds 40 milli moles, per 100 g of the solid matter, the conversion to an acetylide is difficult. As forth is content, amore preferable range can be selected in accordance with the metal species employed.

A metal contained in the propargyl group converted to an acetylide is not particularly limited as long as it presents a catalytic action, and example thereof may include transition metals such as copper, silver and barium. If considering the conformity with an environment, copper and silver are preferable, and copper is more preferable from the viewpoint of the availability. When copper is used as the above-mentioned metal, the content of the propargyl group to be converted to an acetylide in the above resin composition is more preferably 0.1 to 20 milli moles per 100 g of the solid matter in the resin composition.

By converting part of the propargyl group in the above resin composition to an acetylide, a curing catalyst can be introduced into the resin. When the resin composition is prepared in this manner, it is unnecessary to use an organic transition metal complex which is generally difficult to dissolve or disperse in organic solvents and water and is possible to introduce even a transition metal easily through conversion to an acetylide, and therefore even a hard-to-dissolve transition metal compound is applicable to a coating composition without restraint. Further, the occurrence of an organic acid salt as an anion in the electrocoating bath, which is encountered when a transition metal organic acid salt is used, can be avoided and, furthermore, the metal ion will not be removed through ultrafiltration, hence the bath management and the design of electrocoatings become easy.

The resin composition may contain a carbon-carbon double bond where desired. Since the above-mentioned carbon-carbon double bond has high reactivity, curability can be further enhanced.

Preferably, the content of the above-mentioned carbon-carbon double bond is within a range of 10 milli moles (lower limit) to 485 milli moles (upper limit), per 100 g of the solidmatter in the resin composition provided that the total content of the propargyl group and carbon-carbon double bond conditions to be mentioned later are satisfied. When this content is less than 10 milli moles per 100 g of the solid matter, an improvement in curability by addition of the carbon-carbon double bond cannot be adequately exerted, and when it exceeds 485 milli moles per 100 g of the solid matter, the hydration stability in the case of being used as an electrocoating may be affected. As for the content of the carbon-carbon double bond, a more preferable content can be selected in accordance with the resin skeleton employed. In the case of novolak phenol epoxy resins and novolak cresol epoxy resins, for example, the lower limit is preferably 20 milli moles and the upper limit is preferably 375 milli moles, per 100 g of the solid matter in the resin composition.

When the resin composition contains the above carbon-carbon double bond, the total content of the above propargyl group and the above carbon-carbon double bond is preferably within a range of 80 milli moles (lower limit) to 450 milli moles (upper limit), per 100 g of the solid matter in the above resin composition. When this content is less than 80 milli moles per 100 g of the solid matter, curability may become insufficient, and when it exceeds 450 milli moles per 100 g of the solid matter, the sulfonium group content becomes less and a dielectric breakdown voltage may become insufficient. As for the total content of the propargyl group and the carbon-carbon double bond, a more preferable content can be selected in accordance with the resin skeleton employed. In the case of novolak phenol epoxy resins and novolak cresol epoxy resins, for example, the lower limit is more preferably 100 milli moles and the upper limit is more preferably 395 milli moles, per 100 g of the solid matter in the resin composition.

In addition, when the resin composition contains the above carbon-carbon double bond, the total content of the sulfonium group, the propargyl group and the carbon-carbon double bond is preferably 500 milli moles or less per 100 g of the solid matter in the resin composition. When this content exceeds 500 milli moles per 100 g of the solid matter, a resin may not be attained in fact or a desired performance may not be attained. As for the total content of the sulfonium group, the propargyl group and the carbon-carbon double bond, a more preferable content can be selected in accordance with the resin skeleton employed. In the case of novolak phenol epoxy resins and novolak cresol epoxy resins, for example, the total content is more preferably 400 milli moles or less per 100 g of the solid matter in the resin composition.

The above resin composition can favorably be produced, for example, by the step (i) of reacting an epoxy resin having at least two epoxy groups in a molecule with a compound having a functional group capable of reacting with the epoxy group and a propargyl group to obtain an epoxy resin composition containing a propargyl group and the step (ii) of reacting the residual epoxy groups in the epoxy resin composition having a propargyl group(s) obtained in the step (i) with a sulfide/acid mixture to introduce the sulfonium group.

The above-mentioned compound having a functional group capable of reacting with the epoxy group and a propargyl group (hereinafter, referred to as “compound (A)”) may be, for example, a compound having both a functional group capable of reacting with the epoxy group, such as a hydroxyl or carboxyl group, and a propargyl group. As specific examples, there may be given propargyl alcohol and propargylic acid. In particular, propargyl alcohol is preferable from the viewpoint of its availability and good reactivity.

For providing the above resin composition with a carbon-carbon double bond as required, a compound having a functional group capable of reacting with the epoxy group and a carbon-carbon double bond (hereinafter, referred to as “compound (B)”) may be used in combination with the compound (A) in the step (i). As the compound (B), a compound having both a functional group capable of reacting with the epoxy group, such as a hydroxyl or carboxyl group, and a carbon-carbon double bond may be used. Specifically, when the group capable of reacting with the epoxy group is a hydroxyl group, examples of the compound (B) may include 2-hydroxyethyl acrylate, 2-hydroxyethyl methacrylate, hydroxypropyl acrylate, hydroxypropyl methacrylate, hydroxybutyl acrylate, hydroxybutyl methacrylate, allyl alcohol, methacrylic alcohol, and the like. When the group capable of reacting with the epoxy group is a carboxyl group, examples of the compound (B) may include acrylic acid, methacrylic acid, ethacrylic acid, crotonic acid, maleic acid, phthalic acid, itaconic acid; half esters such as maleic acid ethyl ester, fumaric acid ethyl ester, itaconic acid ethyl ester, succinic acid mono(meth)acryloyloxyethyl ester, and phthalic acid mono(meth)acryloyloxyethyl ester; synthetic unsaturated fatty acids such as oleic acid, linolic acid, ricinolic acid, and the like; and nature-derived unsaturated fatty acids such as linseed oil, soybean oil, and the like.

In the step (i), the epoxy resin having at least two epoxy groups in a molecule is reacted with the compound (A) to obtain an epoxy resin composition containing a propargyl group(s) or reacted with the compound (A) and the compound (B) as required to obtain an epoxy resin composition containing a propargyl group(s) and carbon-carbon double bond. In the latter case, in the step (i), the compound (A) and compound (B) may be mixed together in advance and then subjected to reaction, or the compound (A) and compound (B) may be separately subjected to reaction. In addition, the functional group reacting with the epoxy group which the compound (A) has and the functional group reacting with the epoxy group which the compound (B) has may be the same or different.

When, in the step (i), the compound (A) and compound (B) are subjected to reaction with the epoxy resin, the portion between both compounds to be blended may be selected so as to attain the desired content of specified functional groups, for example, the above-mentioned contents of the propargyl group and carbon-carbon double bond.

As for the reaction conditions in the step (i), the reaction is generally carried out at room temperature or 80 to 140° C. for several hours. In addition, publicly known ingredients, which are required for the progress of the reaction, such as a catalyst and/or solvent may be used as required. The completion of the reaction can be checked by measuring an epoxy equivalent, and the functional group introduced can be identified by analysis of nonvolatile content and instrumental analysis of the resin composition obtained. The reaction product thus obtained generally occurs as a mixture of epoxy resins having one or more propargyl groups, or a mixture of epoxy resins having one or more propargyl groups and one or more carbon-carbon double bonds. In this sense, there can be obtained the resin composition having a propargyl group (s), or a propargyl group and carbon-carbon double bond through the step (i).

In the step (ii), the residual epoxy groups in the epoxy resin composition containing a propargyl group, obtained in the step (i), are reacted with a sulfide/acid mixture to introduce a sulfonium group. This introduction of the sulfonium group can be effected by the method which comprises causing the sulfide/acid mixture to react with the epoxy group to conduct introduction of the sulfide and conversion thereof to the sulfonium group or the method which comprises introducing a sulfide and then converting the introduced sulfide to a sulfonium group with an acid, an alkyl halide such as methyl fluoride, methyl chloride or methyl bromide, or the like, if necessary, followed by anion exchange. From the viewpoint of the availability of the reactant, the method using a sulfide/acid mixture is preferred.

The above-mentioned sulfide is not particularly limited, and examples thereof may include aliphatic sulfides, aliphatic-aromatic mixed sulfides, aralkyl sulfides, cyclic sulfides and the like. Specific examples thereof may include diethyl sulfide, dipropyl sulfide, dibutyl sulfide, dihexyl sulfide, diphenyl sulfide, ethyl phenyl sulfide, tetramethylene sulfide, pentamethylene sulfide, thiodiethanol, thiodipropanol, thiodibutanol, 1-(2-hydroxyethylthio)-2-propanol, 1-(2-hydroxyethylthio)-2-butanol, 1-(2-hydroxyethylthio)-3-butoxy-1-propanol, and the like.

The above-mentioned acid is not particularly limited, and examples thereof include formic acid, acetic acid, lactic acid, propionic acid, boric acid, butyric acid, dimethylolpropionic acid, hydrochloric acid, sulfuric acid, phosphoric acid, N-acetylglycine, N-acetyl-β-alanine and the like.

The mixing ratio between the sulfide and acid in the above sulfide/acid mixture is generally and preferably about 100/40 to 100/100 as expressed in terms of sulfide/acid mole ratio.

The reaction in the step (ii) can be carried out, for example, by mixing the epoxy resin composition having a propargyl group, obtained in the step (i), and the above sulfide/acid mixture in an amount selected so as to give the above-mentioned sulfonium group content, for instance, with water in an amount of 5 to 10 moles per mole of the sulfide used and stirring the mixture generally at 50 to 90° C. for several hours. A residual acid value of 5 or less may serve as a criterion in determining the reaction to be completed. The introduction of sulfonium group in the resin composition obtained can be identified by potentiometric titration.

The same procedure can be used also in the case where the sulfide is first introduced and then converted to the sulfonium group. By introducing the sulfonium group after introduction of the propargyl group, as described above, the sulfonium group can be prevented from being decomposed due to heating.

In the case of converting part of the propargyl group in the above resin composition to an acetylide, the conversion to the acetylide can be carried out by the step of reacting the epoxy resin composition, containing a propargyl group, obtained in the step (i) with a metal compound to thereby convert part of the propargyl group in the above epoxy resin composition to the corresponding acetylide. The above-mentioned metal compound is preferably a transition metal compound capable of giving an acetylide, and examples thereof may include complexes or salts of such transition metals as copper, silver and barium. Specific examples thereof may include acetylacetonato-copper, copper acetate, acetylacetonato-silver, silver acetate, silver nitrate, acetylacetonato-barium, and barium acetate. In particular, copper or silver compounds are preferable from the viewpoint of the conformity with an environment, and copper compounds are more preferable because of their ready availability. For example, acetylacetonato-copper is suitably used in view of the ease of bath control.

As for the reaction conditions of converting part of the propargyl group to an acetylide, the reaction is generally carried out at 40 to 70° C. for several hours. The progress of the reaction can be checked by the coloration of the resulting resin composition and/or the disappearance of the methine proton signal on a nuclear magnetic resonance spectrum. Thus, the time when the propargyl group-derived acetylide in the resin composition arrives at a desired level is determined and, at that time, the reaction is terminated. The reaction product obtained is generally a mixture of epoxy resins with one or more propargyl groups converted to an acetylide. A sulfonium group can be introduced, by the step (ii), into the thus obtained epoxy resin composition with part of the propargyl group converted to an acetylide.

The step of converting part of the propargyl group in the epoxy resin composition to an acetylide and the step (ii) can be carried out under common reaction conditions, so that both steps can be carried out simultaneously. The method of carrying out both steps simultaneously can advantageously simplify the production process.

In this way, the resin composition containing a propargyl group and a sulfonium group, and optionally containing a carbon-carbon double bond and/or a propargyl group-derived acetylide as required can be produced while preventing the sulfonium group from being decomposed. Incidentally, acetylides in a dry state are explosive but the reaction is carried out in an aqueous medium and the desired substance can be obtained in the form of an aqueous composition. Therefore, there arises no safety problem.

Since the cationic electrocoating comprises the resin composition and the resin composition itself is curable, it is not always necessary to use a curing agent. However, for further improving the curability, a curing agent may be used. Examples of the curing agent may include compounds having a plurality of at least one species of propargyl groups and carbon-carbon double bonds, for example compounds obtained by adding a compound containing a propargyl group, such as propargyl alcohol, or a compound, containing carbon-carbon double bond, such as acrylic acid to polyepoxide such as a novolak phenol or pentaerythritol tetraglycidyl ether.

It is not always necessary to use a curing catalyst in the cationic electrocoating. However, when a further improvement in curability is required depending on the curing reaction conditions, a transition metal compound in general use may be appropriately added as required. Such compound is not particularly limited, and examples thereof may include complexes or compounds formed by combining a ligand, such as cyclopentadiene or acetylacetone, or a carboxylic acid such as acetic acid, with transition metals such as nickel, cobalt, manganese, palladium and rhodium. The amount of the above curing catalyst to be added is preferably from 0.1 milli mole (lower limit) to 20 milli moles (upper limit) per 100 g of the resin solid matter in the cationic electrocoating.

An amine may further be blended in the cationic electrocoating. By the addition of the amine, the conversion of the sulfonium group to a sulfide by electrolytic reduction in the process of electrodeposition is increased. The amine is not particularly limited, and examples thereof may include amine compounds such as primary to tertiary monofunctional or polyfunctional aliphatic amines, alicyclic amines and aromatic amines. In particular, water-soluble or water-dispersible ones are preferable. Examples of the amines may include alkylamines having 2 to 8 carbon atoms such as monomethylamine, dimethylamine, trimethylamine, triethylamine, propylamine, diisopropylamine and tributylamine; monoethanolamine, dimethanolamine, methylethanolamine, dimethylethanolamine, cyclohexylamine, morpholine, N-methylmorpholine, pyridine, pyrazine, piperidine, imidazoline, imidazole and the like. These may be used alone or two or more of them may be used in combination. In particular, hydroxy amines such as monoethanolamine, diethanolamine and dimethylethanolamine are preferred from the view point of excellent dispersion stability in water.

The above amine can be directly blended in the cationic electrocoating. While in the conventional neutralized amine type electrocoating, the addition of a free amine results in deprivation of the neutralizing acid in the resin, hence in marked deterioration of the stability of the electrocoating solution, no such bath stability trouble will arise in the present invention.

The amount of the above amine to be added is preferably 0.3 meq (lower limit) to 25 meq (upper limit) per 100 g of the resin solid matter in the cationic electrocoating. When this amount is less than 0.3 meq per 100 g, the film thickness retention may become insufficient. When it exceeds 25 meq per 100 g, the effects proportional to the addition amount can no longer be obtained; this is not economical. The lower limit is more preferably 1 meq per 100 g, and the upper limit is more preferably 15 meq per 100 g.

In the cationic electrocoating, there may also be incorporated an aliphatic hydrocarbon group-containing resin composition. The incorporation of the aliphatic hydrocarbon group-containing resin composition results in an improvement in the shock resistance of the coating films obtained. As the aliphatic hydrocarbon group-containing resin composition, there may be mentioned those containing, per 100 g of the solid matter in the resin composition, 5 to 400 millimoles of a sulfonium group, 80 to 135 milli moles of an aliphatic hydrocarbon group containing 8 to 24 carbon atoms and optionally containing an unsaturated double bond in the chain thereof and 10 to 315 milli moles of at least one of a propargyl group and organic groups containing 3 to 7 carbon atoms and having a terminal unsaturated double bond on condition that the total content of the sulfonium group, the aliphatic hydrocarbon group containing 8 to 24 carbon atoms and optionally containing an unsaturated double bond in the chain thereof and the propargyl group and organic groups containing 3 to 7 carbon atoms and having a terminal unsaturated double bond is not more than 500 milli moles per 100 g of the solid matter in the resin composition.

When such an aliphatic hydrocarbon group-containing resin composition is incorporated in the above cationic electrocoating, the resin solidmatter in the cationic electrocoating preferably contains, per 100 g thereof, 5 to 400 milli moles of sulfonium group, 10 to 300 milli moles of the aliphatic hydrocarbon group containing 8 to 24 carbon atoms and optionally containing an unsaturated double bond in the chain thereof and a total of 10 to 485 milli moles of the propargyl group and organic groups containing 3 to 7 carbon atoms and having a terminal unsaturated double bond, and the total content of the sulfonium group, the aliphatic hydrocarbon group containing 8 to 24 carbon atoms and optionally containing an unsaturated double bond in the chain thereof, the propargyl group and the organic groups containing 3 to 7 carbon atoms and having a terminal unsaturated double bond is not more than 500 milli moles per 100 g of the resin solid matter in the cationic electrocoating, and the content of the aliphatic hydrocarbon group containing 8 to 24 carbon atoms and optionally containing an unsaturated double bond in the chain thereof is 3 to 30% by weight relative to the resin solid matter in the electrocoating.

When the aliphatic hydrocarbon group-containing resin composition is incorporated in the above cationic electrocoating and the sulfonium group content level is lower than 5 milli moles per 100 g, any satisfactory curability cannot be attained and, further, the hydratability and bath stability will be poor. When it exceeds 400 milli moles per 100 g, the deposition of films on the surface of the substrate becomes poor. When the content of the aliphatic hydrocarbon group containing 8 to 24 carbon atoms and optionally containing an unsaturated double bond in the chain thereof is less than 80 milli moles per 100 g, the shock resistance will not be improved to a satisfactory extent and, when it exceeds 350 milli moles per 100 g, the resin composition becomes difficult to handle. When the total content of the propargyl group and the organic groups containing 3 to 7 carbon atoms and having a terminal unsaturated double bond is less than 10 milli moles per 100 g, no satisfactory curability can be manifested on the occasion of combined use of another resin and/or another curing agent and, when it exceeds 315 milli moles per 100 g, the shock resistance will not be improved to a satisfactory extent. The total content of the sulfonium group, the aliphatic hydrocarbon group containing 8 to 24 carbon atoms and optionally having an unsaturated double bond in the chain thereof, the propargyl group and the organic groups containing 3 to 7 carbon atoms and having a terminal unsaturated double bond is not more than 500 milli moles per 100 g of the solid matter in the resin composition. When it exceeds 500 millimoles, any corresponding resin cannot be obtained in actuality or the desired performance characteristics cannot be obtained in some instances.

The above-mentioned cationic electrocoating may further contain another components used in an ordinary cationic electrocoating as required. The above-mentioned another component is not particularly limited, and examples thereof may include a pigment, a rust preventive, a pigment dispersion resin, a surfactant, an antioxidant and an ultraviolet absorber. However, when the above-mentioned components are used, it is preferred to adjust the amount of the component to be blended paying attention to the retention of a dielectric breakdown voltage.

The pigment is not particularly limited, and examples thereof may include coloring pigments such as titanium dioxide, carbon black and red iron oxide; rust-preventive pigments such as basic lead silicate and aluminum phosphomolybdate; and extender pigments such as kaoline, clay and talc. Examples of the rust preventive, specifically, may include calcium phosphite, zinc calcium phosphite, calcium-carrying silica, calcium-carrying zeolite, and the like. The total amount of the above-mentioned pigments and rust preventives to be added is preferably 0% by weight (lower limit) to 50% by weight (upper limit) in terms of the solid matter in the cationic electrocoating.

The pigment dispersion resins are used to stably disperse the pigments in the cationic electrocoating. The pigment dispersion resins are not particularly restricted but include those pigment dispersion resins which are in general use. A pigment dispersion resin containing a sulfonium group and an unsaturated bond within the resin may also be used. Such pigment dispersion resin containing a sulfonium group and an unsaturated bond can be obtained, for example, by the method comprising reacting a sulfide compound with a hydrophobic epoxy resin obtained by reacting a bisphenol-based epoxy resin with a half-blocked isocyanate, or reacting the resin with a sulfide compound in the presence of a monobasic acid and a hydroxyl group-containing dibasic acid. The pigment dispersion resins can also stably disperse the rust preventives containing no heavy metal in the cationic electrocoating.

The cationic electrocoating can be prepared, for example, by admixing the resin composition with the above-mentioned other ingredients as required and dissolving or dispersing the resulting composition in water. On the occasion of use in the electrodeposition step, the bath solution/dispersion prepared preferably has a nonvolatile matter content of 5% by weight (lower limit) to 40% by weight (upper limit). The preparation is preferably carried out in such a way that the contents of the propargyl group, carbon-carbon double bond and sulfonium group in the electrocoating may not deviate from the respective is ranges indicated above referring to the resin composition.

In the method of coating an electric wire according to the present invention, the step (I) can be performed using an electrodeposition apparatus in which the usual cationic electrodeposition can be carried out. For example, the electrodeposition can be carried out using a cationic electrodeposition apparatus which comprise electrodeposition means, washing means and heating means combined in that order. In this way, the insulating wire having the high dielectric breakdown voltage can be obtained in an efficient manner. Examples of the electrodeposition apparatus which can be used may include a horizontal electrodeposition apparatus in which electrodeposition is carried out while an article to be coated is pulled horizontally, and a vertical electrodeposition apparatus in which an article to be coated is introduced into the electrocoating bath from the bottom thereof and pulled out from the top of the electrocoating bath.

The above-mentioned electrodeposition means is aimed to form a film on the surface of an electric wire, which is an article to be coated by cationic electrodeposition using a cationic electrocoating. The above-mentioned electrodeposition means is not particularly limited as long as it is one capable of conducting cationic electrodeposition.

In operating the electrodeposition means, the method comprising, for example, immersing an article to be coated in the cationic electrocoating for utilizing the article as a cathode, and applying a voltage generally within the range of 50 to 450 V between the cathode and an anode may be given as an example. When the voltage applied is lower than 50 V, the dielectric breakdown voltage may be possibly lowered and insufficient electrodeposition will result. When it exceeds

V, the electricity consumption uneconomically increases. When the cationic electrocoating is used and a voltage within the range is applied, a uniform film can be formed on the whole material surface without any rapid increase in film thickness in the process of electrodeposition. In ordinary cases, a bath temperature of the cationic electrocoating in applying the above voltage is preferably 10 to 45° C.

The above-mentioned washing means is intended for washing the article with the cationic electrocoating adhering thereto to remove the electrocoating bath liquid. The washing means is not particularly restricted but may be any the conventional washing apparatus. For example, there may be given an apparatus in which the electrodeposited article is washed using, as a washing liquid, the filtrate obtained by ultrafiltration of the electrocoating bath liquid. As the above-mentioned heating means, there may be specifically given a hot air drying oven, a near-infrared heating oven, a far-infrared heating oven, and an induction heating oven, for instance.

In the method of coating an electric wire of the present invention, after the step (I) is performed, a second insulating film is formed on the first insulating film formed in the step (I) using an insulating coating. By performing the step (I) and the step (II), an insulating wire can be obtained which has a first insulating film on an article to be coated, and a second insulating film formed thereon. Thereby, an insulated wire having a higher dielectric breakdown voltage can be obtained.

The insulating coating is not particularly limited as long as it is a coating capable of forming an insulating film having a high dielectric breakdown voltage, and examples thereof may include various conventionally known insulating coatings formed by containing organic resins such as polyvinyl formal resin, polyamide resin, polyimide resin, polyamide-imide resin, polyester-imide resin, polyester resin, polyurethane resin and epoxy resin.

Examples of an insulating coating formed by containing the above-mentioned polyvinyl formal resin may include a coating containing a polyvinyl formal resin and a phenol resin and, as a commercially available product, PVF S7-24 (made by Totoku Toryo Co., Ltd.) and the like are suitably used.

Examples of an insulating coating formed by containing the above-mentioned polyamide resin may include aramid (aromatic polyamide) coatings, nylon MXD 6 coatings and the like. In particular, aramid coatings are preferred in point of heat resistance, mechanical strength and the like.

Examples of an insulating coating formed by containing the above-mentioned polyimide resin may include total aromatic polyimide coatings and the like and, as a commercially available product, Pyre-ML (product name, made by DuPont K.K.), TORAYNEECE 3000 (product name, made by Toray Industries, Inc.) and the like are suitably used.

Examples of an insulating coating formed by containing the above-mentioned polyamide-imide resin may include a coating prepared by reacting tricarboxylic anhydride with diisocyanate, and the like and, as a commercially available product, NEOHEAT AI (made by Totoku Toryo Co., Ltd.) and the like are given.

Examples of an insulating coating formed by containing the above-mentioned polyester-imide resin may include a coating prepared by further reacting imide-dicarboxylic acid, which is a reaction product of tricarboxylic anhydride and diamine, with a polyhydric alcohol and, as a commercially available product, NEOHEAT 8600A (made by Totoku Toryo Co., Ltd.) and the like are given.

Examples of an insulating coating formed by containing the above-mentioned polyester resin may include alkyd resin coatings, especially, glycerine-modified alkyd resin coatings, tris(hydroxyethyl)isocyanurate (THEIC)-modified alkyd resin coatings, and the like and, as a commercially available product, NEOHEAT 8200K1 (made by Totoku Toryo Co., Ltd.) and the like are given.

Examples of an insulating coating formed by containing the above-mentioned polyurethane resin may include a coating prepared by reacting diisocyanate with a polyester resin, and the like and, as a commercially available product, TPU F1 (made by Totoku Toryo Co., Ltd.) and the like are given.

Examples of an insulating coating formed by containing the above-mentioned epoxy resin may include a coating containing a bisphenol A type epoxy resin and a phenolic resin, and the like and, as a commercially available product, CEMEDINE 110 (made by CEMEDINE Co., Ltd.) and the like are given. Among the insulating coatings described above, the insulating coating formed by containing the above-mentioned polyamide-imide resin is preferred in that the obtained insulating film has a higher dielectric breakdown voltage.

In the method of coating an electric wire of the present invention, the step (II) can be performed by a conventionally known method such as an application and baking of the above-mentioned insulating coating. As a method of applying the above-mentioned insulating coating, a dice technique and a felt technique are conventionally well known.

An article to be coated, to which the method of coating an electric wire of the present invention is applicable, is not particularly limited as long as it exhibits conductivity through which cationic electrodeposition can be conducted, and examples thereof may include electric wires comprising metals such as iron, copper, aluminum, gold, silver, nickel, tin, zinc, titanium and tungsten, and alloys containing these metals. In particular, a substance consisting of metals such as copper, gold, aluminum and iron, or alloys based on these metals are preferable. In addition, a cross-sectional profile of an article to be coated, to which the method of coating an electric wire is applicable is not particularly limited, but is preferably round.

The insulated wire obtained by the above method of coating an electric wire is such that an insulating film composed of a first insulating film and a second insulating film is uniformly formed on the surface of an article, and a dielectric breakdown voltage thereof is enhanced. Thereby, the insulated wire can be preferably applied to such utilities that the previous insulating coating is applied with difficulty. Such the insulated wire is also one of the present inventions.

Further, the present invention is also a method of coating an electric wire having edges, in which a an electric wire having edges is used as an article and, as the cationic electrocoating and/or insulating coating, a coating containing crosslinked resin particles is used in the above method of coating an electric wire. That is, the present invention is also a method of coating an electric wire having edges comprising a step (I) of forming a first insulating film by cationic electrodeposition using a cationic electrocoating, and a step (II) of forming a second insulating film on the first insulating film formed in the step (I) using an insulating coating, said cationic electrocoating containing a resin composition of which a hydratable functional group is reduced directly by an electron and passivated, resulting in deposition of a film and the cationic electrocoating and/or the insulating coating containing crosslinked resin particles.

Since at least one of the cationic electrocoating and the insulating coating contains the crosslinked resin particle as described above, even at edge of an article at which it is difficult to form an insulating film with a sufficient film thickness previously, a insulating film having a sufficient film thickness can be formed, and an insulated wire having a high dielectric breakdown voltage can be obtained.

The crosslinked resin particle has the function of providing a thixotropic property in the cationic electrocoating and/or the insulating coating. Thus, in baking and curing the applied film to form an insulating film, an insulating film can be formed in a sufficient film thickness even at edges of an article to be coated and, as a result, an insulated wire having a high dielectric breakdown voltage can be attained.

For example, when the step (I) is performed using the cationic electrocoating containing the crosslinked resin particles, the function of the crosslinked resin particle to provide a thixotropic property allows the whole surface of the article to be coated, that is, the whole surface including the edges to be coated with a sufficient insulating film and an insulated wire to be obtained to be provided with a high dielectric breakdown voltage. In addition, also when the step (II) is performed using the insulating coating containing crosslinked resin particles, a second insulating film with a sufficient film thickness is formed at edges, and an insulated wire having a high dielectric breakdown voltage can be obtained. Since the crosslinked resin particle imparts such the function, when the step (I) is performed using the cationic electrocoating containing crosslinked resin particles, and the step (II) is performed using the insulating coating containing crosslinked resin particles, at edges of an article, coating with a first insulating film and a second insulating film is sufficiently done, and as a result, a dielectric breakdown voltage of the resulting insulated wire can be made higher. Therefore, from a viewpoint that the resulting insulated wire has a higher dielectric breakdown voltage, it is preferable to employ each coating containing crosslinked resin particles in both of the step (I) and the step (II). In addition, when the case of use of crosslinked resin particle only in the step (I) and the case only in the step (II) are compared, it is preferable to use only in the step (I) from a viewpoint that the resulting insulated wire has a higher dielectric breakdown voltage.

When the cationic electrocoating and the insulating coating do not contain the crosslinked resin particles or contains non-crosslinked resin particles, a high dielectric breakdown voltage may not be imparted to an electric wire having edges since edges cannot be coated in a sufficient film thickness.

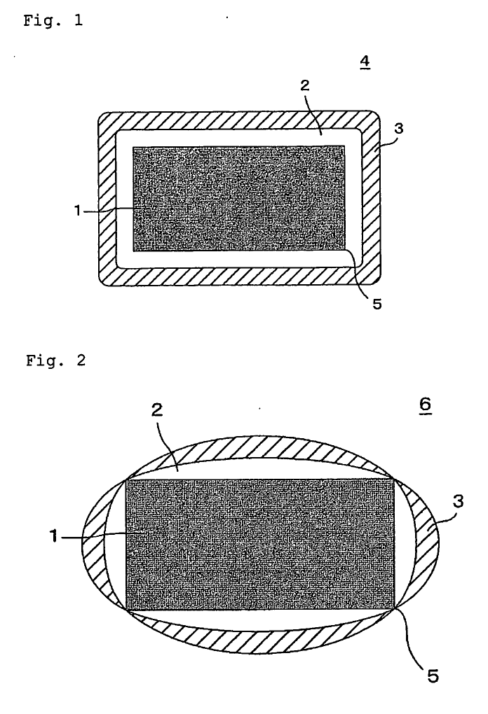

FIG. 1 shows an example of a conceptual view of the insulated wire obtained by performing the step (I) using a cationic electrocoating containing crosslinked resin particles and performing the step (II) using an insulating coating containing crosslinked resin particles in the method of coating an electric wire having edges in accordance with the present invention. FIG. 1 shows an insulated wire 4, which is obtained by forming a first insulating film 2, to be formed by electrodeposition using the cationic electrocoating, and a second insulating film 3, to be formed by applying the insulating coating on a shaped wire 1 having a rectangular shape in the cross-sectional profile. The insulated wire 4, obtained in the case where coatings containing the crosslinked resin particles are used in the step (I) and the step (II), is provided with the first insulating film 2 and the second insulating film 3 with a sufficient film thickness even on edges 5 of the shaped wire 1. Accordingly, the insulated wire 4 obtained by the above coating method has a high dielectric breakdown voltage.

On the other hand, FIG. 2 shows an example of a conceptual view of the insulated wire obtained by forming a first insulating film using a cationic electrocoating containing no crosslinked resin particles and forming a second insulating film using a insulating coating containing no crosslinked resin particles. The insulated wire 6, obtained in the case where coatings containing no crosslinked resin particles are used, is not provided with the first insulating film 2 and the second insulating film 3 with a sufficient film thickness on the edges 5 of the shaped wire 1. Consequently, the insulated wire 6 obtained by using the cationic electrocoating and insulating coating containing no crosslinked resin particles has a lower dielectric breakdown voltage in comparison to the insulated wire obtained by the method of coating an electric wire having edges in accordance with the present invention.

The crosslinked resin particle is not particularly limited, but includes a compound obtained by a so-called emulsion method in which a polymerizable monomer is crosslinked in an aqueous medium while being emulsion polymerized in the presence of a resin having a emulsifying power and an initiator, and a compound obtained by a so-called NAD method in which a polymerizable monomer is crosslinked while being copolymerized in a mixed solution of an organic solvent and a dispersion-stable resin soluble in an organic solvent, which are methods well known to those skilled in the art.

As a volume-average particle diameter of the crosslinked resin particles, it is preferred that specifically, a lower limit is 0.05 μm and an upper limit is 1 μm. When it is less than 0.05 μm, the thickness of film at the edges may become insufficient, and when it exceeds 1 m, an appearance of the insulating film may be deteriorated. More preferably, the lower limit is 0.07 μm and the upper limit is 0.5 μm. This volume-average particle diameter can be controlled by adjusting, for example, the composition or the polymerization conditions of a polymerizable monomer. The volume-average particle diameter can be determined, for example, by a laser-light-scattering method and the like.

The crosslinked resin particle is preferably one of which a hydratable functional group is reduced directly by electrons and passivated. It is possible to provide a good thixotropic property for a coating by using such crosslinked resin particles in the step (I). Thereby, a first insulating film can be sufficiently formed even at edges of an article to be coated, and an insulated wire having a high dielectric breakdown voltage can be attained.

In the step (I), the mechanism of deposition of the crosslinked resin particle on the cathode as caused by voltage application is represented by the above formula (1). The crosslinked resin particle is passivated to be deposited by providing the hydratable functional group in the crosslinked resin particle (substrate; expressed by “S” in the formula) with electrons on the cathode.

That is, when the reaction represented by the above formula (1) occurs, the hydratable functional group existing in the crosslinked resin particle in the cationic electrocoating is directly reduced on the cathode, resulting in insolubilization and deposition of the crosslinked resin particle. The film deposited according to this mechanism has a high dielectric breakdown voltage.

When contained in the cationic electrocoating, the crosslinked resin particle is preferably obtained by emulsion polymerizing an α,β-ethylenically unsaturated monomer mixture using a resin having an onium group as an emulsifier. By containing such a crosslinked resin particle, it is possible to coat edges sufficiently with an insulating film and to obtain an insulated wire having a higher dielectric breakdown voltage.

The above-mentioned α,β-ethylenically unsaturated monomer mixture generally contains poly(meth)acrylate having two or more α,β-ethylenically unsaturated bonds in a molecule in order to crosslink the resin particle. The content of the poly(meth)acrylate having two or more α,β-ethylenically unsaturated bonds in a molecule is preferably 5% by weight (lower limit) to 20% by weight (upper limit) relative to 100% by weight of total solid matter in the α,β-ethylenically unsaturated monomer mixture. When this content is less than 5% by weight, crosslinking of the resin particle does not adequately proceed, and when it exceeds 20% by weight, crosslinking of the resin particle proceeds excessively; therefore, physical properties of an insulating film to be obtained may be deteriorated.

As the above-mentioned poly(meth)acrylate having two or more α,β-ethylenically unsaturated bonds in a molecule, there may be given, for example, a compound having a structure in which a plurality of (meth)acrylic acids combine with dihydric or higher alcohol in the form of an ester linkage, and the like. Examples of the above-mentioned compound having a structure in which a plurality of (meth)acrylic acids combine with dihydric or higher alcohol in the form of an ester linkage may include ethylene glycol di(meth)acrylate, triethylene glycol di(meth)acrylate, neopentyl glycol di(meth)acrylate, tetraethylene glycol di(meth)acrylate, trimethylol propane tri(meth)acrylate, and the like. These compounds may be used alone or in combination of two or more kinds of them.

The α,β-ethylenically unsaturated monomer mixture contains a general α,β-ethylenically unsaturated monomer besides the above-mentioned poly(meth)acrylate. As the above-mentioned general α,β-ethylenically unsaturated monomer, there may be given a compound having a reactive functional group and a compound having no reactive functional group.

Examples of the α,β-ethylenically unsaturated monomer having the reactive functional group may include hydroxyethyl (meth)acrylate, hydroxypropyl(meth)acrylate, hydroxybutyl (meth)acrylate, allyl alcohol, methacrylic alcohol, hydroxyl group-containing compounds such as ε-caprolactam adduct of hydroxyethyl(meth)acrylate; epoxy group-containing compounds such as glycidyl(meth)acrylate, and the like.

When the α,β-ethylenically unsaturated monomer having the reactive functional group is contained in the above-mentioned α,β-ethylenically unsaturated monomer mixture, the content of the α,β-ethylenically unsaturated monomer having the reactive functional group is preferably 20% by weight or less relative to 100% by weight of the above-mentioned α,β-ethylenically unsaturated monomer mixture. When the content exceeds 20% by weight, the water resistance of a film to be obtained may be deteriorated. Both of the hydroxyl group value or epoxy value of the above-mentioned α,β-ethylenically unsaturated monomer mixture in this case is preferably 20 or less. When it exceeds 20, the water resistance or the insulating property of a film to be obtained may be deteriorated.

On the other hand, examples of the α,β-ethylenically unsaturated monomer having no reactive functional group may include (meth)acrylic ester such as methyl(meth)acrylate, ethyl (meth)acrylate, n-propyl(meth)acrylate, iso-propyl (meth)acrylate, n-butyl(meth)acrylate, isobutyl (meth)acrylate, t-butyl(meth)acrylate, 2-ethylhexyl (meth)acrylate, lauryl(meth)acrylate, isobornyl (meth)acrylate, cyclohexyl(meth)acrylate, t-butylcyclohexyl (meth)acrylate, dicyclopentadienyl(meth)acrylate, and dihydrodicyclopentadienyl(meth)acrylate; polymerizable amide compounds such as (meth)acrylamide, N-methylol (meth)acrylamide, N-butoxymethyl(meth)acrylamide, N,N-dimethyl(meth)acrylamide, N,N-dibutyl(meth)acrylamide, N,N-dioctyl(meth)acrylamide, N-monobutyl(meth)acrylamide, N-monooctyl(meth)acrylamide, 2,4-dihydroxy-4′-vinylbenzophenone, N-(2-hydroxyethyl)acrylamide, and N-(2-hydroxyethyl)methacrylamide; polymerizable aromatic compounds such as styrene, α-methylstyrene, vinyl ketone, t-butylstyrene, p-chlorostyrene, and vinyl naphthalene; polymerizable nitriles such as acrylonitrile, and methacrylonitrile; ethylene, propylene and the like; vinyl esters (e.g., α-olefins such as vinyl acetate and vinyl propionate); diens such as butadiene and isoprene.

In the resin having an onium group used as an emulsifier in emulsion polymerization for preparing the crosslinked resin particle, the number of onium groups is preferably 2 to 15 per one molecule. When the number of onium groups is less than 2 per one molecule, the stability of dispersion may be deteriorated, and when it exceeds 15, the water resistance of an insulating film to be obtained may be deteriorated. In addition, as the onium group, there may be given an ammonium group or a sulfonium group, but the ammonium group is preferable from the viewpoint of water resistance.

Examples of the resin having the ammonium group or sulfonium group may include an acrylic resin, a polyester resin, an epoxy resin, a urethane resin and the like. An acrylic resin or an epoxy resin is preferable from the viewpoint of design. The above-mentioned acrylic resin or epoxy resin can be attained by various methods but it can be easily obtained by adding a tertiary amine compound or sulfide and an organic acid to an acrylic resin or an epoxy resin, having an epoxy group, to convert the acrylic resin or the epoxy resin to a quaternary ammonium compound or a tertiary sulfonium compound. In addition, this conversion to a quaternary ammonium compound or a tertiary sulfonium compound may be carried out by previously preparing a mixture of a tertiary amine compound and an organic acid or sulfide and an organic acid and adding this mixture to the acrylic resin or the epoxy resin, having an epoxy group, as an ammonium quaternizing agent or a sulfonium tertiarizing agent.

An acrylic resin having an epoxy group, which is used for conversion to a quaternary ammonium compound or a tertiary sulfonium compound, can be obtained by polymerizing a mixed monomer solution comprising an α,β-ethylenically unsaturated monomer having an epoxy group such as glycidyl(meth)acrylate and another α,β-ethylenically unsaturated monomer according to an ordinary technique.

In this method of conversion to a quaternary ammonium compound and a tertiary sulfonium compound, the amount of the α,β-ethylenically unsaturated monomer having an epoxy group may be determined depending on the number of ammonium groups and sulfonium groups described above because an epoxy group is converted to an ammonium group by being ring-opened with a tertiary amine compound or to a sulfonium group by being ring-opened with sulfide. The above-mentioned another α,β-ethylenically unsaturated monomer refers to the above-mentioned general α,β-ethylenically unsaturated monomer, for example, in the α,β-ethylenically unsaturated monomer mixture described above.

Examples of the epoxy resin include the epoxy resins described above.

A number-average molecular weight of the above-mentioned acrylic resin or epoxy resin, having an epoxy group, is preferably 2000 to 20000. When the number-average molecular weight is less than 2000, the thickness of film at the edges may be insufficient, and when it exceeds 20000, a rise in viscosity of an emulsifier may become a problem.

The tertiary amine compound for introducing above-mentioned ammonium group in an acrylic resin or an epoxy resin is not particularly limited, but includes trimethylamine, triethylamine, tributylamine, trioctylamine, dimethylethanolamine, methyldiethanolamine, and the like. Incidentally, the amount of the tertiary amine compound may be determined in conformity with the amount of ammonium group to be introduced.

The sulfide for introducing above-mentioned sulfonium group in an acrylic resin or an epoxy resin is not particularly limited, but examples thereof may include the sulfides described above.

An organic acid used for conversion to a quaternary ammonium compound or a tertiary sulfonium compound is not particularly limited, and examples thereof may include the acids described above. In particular, lactic acid, acetic acid and dimethylolpropionic acid are preferable in point of the stability in emulsifying.

In this conversion to a quaternary ammonium compound or a tertiary sulfonium compound, the molar ratio among an epoxy group, a tertiary amine compound or sulfide, and an organic acid in an acrylic resin or an epoxy resin having an epoxy group is preferably 1:1:1 to 1:1:2. A reaction of conversion to a quaternary ammonium compound or a tertiary sulfonium compound is generally conducted over 2 to 10 hours and may be heated to 60 to 100° C. as required.

The crosslinked resin particle, contained in a cationic electrocoating composition, in the present invention can be preferably obtained by conducting emulsion polymerization using a resin having an onium group obtained in such a manner as described above as an emulsifier. The emulsion polymerization can be conducted using a method being usually well known. For example, this can be conducted by dissolving an emulsifier in an aqueous medium including water, or an organic solvent such as alcohol or the like as required and adding the above-mentioned α,β-ethylenically unsaturated monomer mixture and an initiator dropwise to this solution under being heated and stirred. An α,β-ethylenically unsaturated monomer mixture previously emulsified with an emulsifier and water may be added dropwise similarly.

The above-mentioned emulsion polymerization is preferably conducted following a procedure in which an emulsifier is dissolved in an aqueous medium and after an initiator is added dropwise to this solution under being heated and stirred, part of the α,β-ethylenically unsaturated monomer is added dropwise and, then, the rest of α,β-ethylenically unsaturated monomer mixture, which has been previously emulsified with an emulsifier and water, is added dropwise. By emulsion polymerizing using this procedure, the deviation from a desired particle diameter is reduced and preferable crosslinked resin particles can be obtained.

The initiator is not particularly limited, and preferable examples thereof may include oily azo compounds (e.g., azobisisobutyronitrile, 2,2′-azobis(2-methylbutyronitrile), 2,2′-azobis(2-(2-imidazoline-2-yl)propane), 2,2′-azobis(2,4-dimethylvaleronitrile) and the like); aqueous compounds (e.g., 4,4′-azobis(4-cyanovalerate), 2,2′-azobis(N-(2-carboxyethyl)-2-methylpropionamidine) of anionic compounds, and 2,2′-azobis(2-methylpropionamidine) of cationic compounds; oily redox peroxides (e.g., benzoylperoxide, p-chlorobenzoyl peroxide, lauroyl peroxide, t-butyl perbenzoate, and the like); and aqueous peroxides (e.g., potassium persulfate, ammonium persulfate, and the like).

The resin having an onium group, described above, is preferably used as the emulsifier. Further, it is possible to use compounds usually used by those skilled in the art or reactive emulsifiers, e.g., ANTOX MS-60 (made by Nippon Surfactant Co., Ltd.), ELEMINOL JS-2 (made by Sanyo Kasei Co., Ltd.), ADEKARIA SOAP NE-20 (made by Asahi Denka Co., Ltd.), and AQUARON HS-10 (made by Daiichi Kogyo Seiyaku Co., Ltd.), in combination with the resin having an onium group. Here, the above-mentioned reactive emulsifier is assumed to be not included in an α,β-ethylenically unsaturated monomer contained in the monomer mixture described above.

The ratio by weight between the above-mentioned resin having an onium group in terms of solid matter and the above-mentioned α,β-ethylenically unsaturated monomer mixture (weight of the resin having an onium group in terms of solid matter/weight of the α,β-ethylenically unsaturated monomer mixture) is preferably 5:95 to 50:50. When the above-mentioned ratio by weight is out of the above range, the appearance of an insulating film may be deteriorated.

In the above emulsion polymerization, mercaptan such as lauryl mercaptan and a chain transfer agent such as α-methylstyrene dimer may be used as required in order to adjust a molecular weight.

A reaction temperature in the above emulsion polymerization depends on an initiator, and for example, it is preferably 60 to 90° C. in azo initiators and 30 to 70° C. in redox initiators. Generally, a reaction time is 1 to 8 hours. The ratio of the initiator to the total amount of the α,β-ethylenically unsaturated monomer mixture is generally 0.1% by weight (lower limit) to 5% by weight (upper limit). Preferably, the above lower limit is 0.2% by weight and the above upper limit is 2% by weight.

The cationic electrocoating in the present invention preferably contains the crosslinked resin particle obtained in a manner described above in an amount of 0.5 to 40% by weight relative to the resin solid matter in a coating composition. When the above-mentioned content of the crosslinked resin particle is less than 0.5% by weight, the thickness of film at the edges may become insufficient, and when it exceeds 40% by weight, an appearance of the insulating film may be deteriorated. The above content is more preferably 1 to 30% by weight. Here, when the crosslinked resin is obtained by the NAD method, the content of the crosslinked resin particle includes the polymerizable monomer crosslinked through copolymerization and the dispersion-stable resin.

The insulating coating in the present invention preferably contains the crosslinked resin particle obtained in a manner described above in an amount of 0.5 to 40% by weight relative to the resin solid matter in a coating composition. When the above-mentioned content of the crosslinked resin particle is less than 0.5% by weight, the thickness of film at the edges may become insufficient, and when it exceeds 40% by weight, an appearance of the insulating film may be deteriorated. The above content is more preferably 1 to 30% by weight.

In addition, in the case where the insulating coating composition of the present invention is used in the form of an organic solvent, the crosslinked resin particle obtained by the above-mentioned NAD method can be contained in the insulating coating composition as it is, but when the crosslinked resin particle is obtained by the above-mentioned emulsion method, a crosslinked resin particle, obtained by eliminating water content through substituting a solvent for, azeotropically distilling, centrifuging, filtering or drying the obtained crosslinked resin particle to convert the crosslinked resin particle to an organic solvent type, can be contained in the insulating coating composition.

Examples of the cationic electrocoating and the insulating coating used in the method of coating an electric wire having edges include those coatings having the same compositions as those of the above cationic electrocoating and insulating coating in respect other than inclusion of the crosslinked resin particle.

It is preferable that the resin composition in a cationic electrocoating has a sulfonium group and a propargyl group. By using the resin composition having a sulfonium group and a propargyl group, an insulated wire having a higher dielectric breakdown voltage can be obtained.

Preferably, the resin composition has a sulfonium group content of 5 to 400 milli moles, a propargyl group content of 10 to 495 milli moles and a total content of the sulfonium and propargyl groups of 500 milli moles or less, per 100 g of the solid matter in the resin composition.

Preferably, the resin composition includes an epoxy resin having a novolak cresol epoxy resin or a novolak phenol epoxy resin as a skeleton and having a number-average molecular weight of 700 to 5000

In addition, preferably, resin composition also has a sulfonium group content of 5 to 250 milli moles, a propargyl group content of 20 to 395 milli moles and a total content of the sulfonium and propargyl groups of 400 milli moles or less, per 100 g of the solid matter in the resin composition.

The above-mentioned method of coating an electric wire having edges is favorably applicable to coating of an article to be coated having edges and can also be favorably applied particularly to coating of an electric wire having a small curvature of the edges in the cross-sectional profile such as a shaped wire, which is considered to be difficult to coating. As a value of curvature of an edge grows smaller, generally, it becomes difficult to sufficiently form an insulating film on an edge. However, for example, when the method of coating an electric wire having edges in accordance with the present invention is applied to an article to be coated, having a curvature of the edges of 1 to 20%, an insulated having a dielectric breakdown voltage of 1 to 15 kV, can be attained. In addition, the curvature used in this description refers to one, which is represented by (a radius of a curve of the edge/a length of a shorter side of two sides containing the edge)×100 with respect to the edge and two sides containing the edge in a cross section of the electric wire.

The insulated wire obtained by the method of coating an electric wire having edges is such that an insulating film composed of a first insulating film and a second insulating film is formed with a sufficient film thickness on the whole surface of an article, that is, on the whole surface including the edges, and the dielectric breakdown voltage is more heightened. Therefore, the insulated wire obtained by this coating method can be preferably used as one having a high dielectric breakdown voltage. Such the insulated wire is one of the present inventions.

The method of coating an electric wire having edges comprising a step (I) of forming a first insulating film by cationic electrodeposition using a cationic electrocoating, and a step (II) of forming a second insulating film on the first insulating film formed in the step (I) using an insulating coating, said cationic electrocoating containing a resin composition of which a hydratable functional group is reduced directly by an electron and passivated, resulting in deposition of a film and the cationic electrocoating and/or the insulating coating containing crosslinked resin particles. In the method of coating an electric wire, since the step (I) is performed using a cationic electrocoating containing the resin composition, an insulated wire having a high dielectric breakdown voltage can be obtained by further performing the step (II) after the step (I) is performed. In addition, in particular, when the resin composition has a sulfonium group and a propargyl group, an insulated wire having a higher dielectric breakdown voltage can be obtained. Therefore, the insulated wire obtained by the method of coating an electric wire of the present invention can be also applied to utilities requiring a higher dielectric breakdown voltage.

Further, the method of coating an electric wire having edges of the present invention can form an insulating film even at the edge of an electric wire having edges, by using a cationic electrocoating and/or an insulating coating containing crosslinked resin particles in the method of coating an electric wire.

Therefore, by using the method of coating an electric wire having edges, even when an article to be coated having edges is used, an insulated wire having a high dielectric breakdown voltage can be obtained. In addition, in particular, when the resin composition in the cationic electrocoating has a sulfonium group and a propargyl group, an insulated wire having a higher dielectric breakdown voltage can be obtained.

### EXAMPLES

Hereinafter, the present invention will be described more specifically by way of examples, but the present invention is not limited to these examples. In the examples, “part(s)” means “part (s) by weight”, unless otherwise specified. “%” means “% by weight” unless otherwise indicated.

### Production Example 1

Production of an Epoxy Resin 1 Composition Having a Sulfonium Group and a Propargyl Group

In a separable flask provided with a stirrer, a thermometer, a nitrogen gas inlet tube and a reflux cooling tube, 100.0 parts of EPOTOHTO YDCN-701 with an epoxy equivalent of 200.4 (cresol novolak type epoxy resin made by Tohto Kasei Co., Ltd.), 23.6 parts of propargyl alcohol and 0.3 part of dimethylbenzylamine were put, and the mixture was heated to 105° C. and reacted at that temperature for 3 hours to obtain a resin composition containing a propargyl group with an epoxy equivalent of 1580. Acetylacetonate-copper (2.5 parts) was added thereto, and the reaction was allowed to proceed at 50° C. for 1.5 hours. It was verified that part of the terminal hydrogens of the added propargyl groups was disappeared by proton (1H) NMR (propargyl converted to acetylide equivalent to 14 milli moles per 100 g of the resin solid matter).

1-(2-hydroxyethylthio)-2,3-propanediol (10.6 parts), 4.7 parts of glacial acetic acid and 7.0 parts of deionized water were added thereto, and the reaction was allowed to proceed for 6 hours while maintaining the temperature at 75° C. After verification that the residual acid value is 5 or less, 43.8 parts of deionized water was added to give an intended resin composition solution. This solution had a solid matter content of 70.0% by weight and the sulfonium value of 28.0 milli moles per 100 g varnish. The number-average molecular weight (determined by GPC on the polystyrene equivalent basis) was 2443.

### Production Example 2

Production of a Cationic Electrocoating

To 142.9 parts of the resin composition obtained in Production Example 1 was added 157.1 parts of deionized water, and the mixture was stirred in a high-speed rotary mixer for 1 hour and, then, 373.3 parts of deionized water was added thereto and this aqueous solution was adjusted so as to have a solid matter content of 15% by weight to obtain a cationic electrocoating.

### Example 1

A first insulating film was formed on the surface of a copper round wire (0.2 mmφ) without edges having a round shape in the cross-sectional profile, by subjecting the wire to the following pretreatment means, electrodeposition means, washing means and heating means.

[Pretreatment Means]

(1) The electric wire was degreased with SURF POWER (made by NIPPON PAINT Co., Ltd.) at a treatment temperature of 45° C. for a treatment time of 60 seconds.

(2) The degreased electric wire was washed with water by spraying for 30 seconds.

[Electrodeposition Means]

The wire after water washing was immersed in the cationic electrocoating obtained in Production Examples 2 stored as an electrocoating bath liquid in an electrocoating bath and cationic electrodeposited at a bath temperature of 30° C. for 5 seconds with a voltage of 100 V being applied (with the wire as the cathode and the counter electrode as the anode).

[Washing Means]

The wire obtained after immersion period of cationic electrodeposition was washed with water by spraying for 30 seconds to removed the cationic electrocoating adhering to the wire.

[Heating Means]

The wire after washing was heated in a hot air drying oven at 190° C. for 25 minutes to form a first insulating film.

NEOHEAT AI (insulating coating containing polyamide-imide resin, made by Totoku Toryo Co., Ltd.) was applied using a coating dice to the obtained wire on which the first insulating film was formed and then heated at 190° C. for 25 minutes. By repeating this cycle of applying the insulating coating and heat setting 3 times, the second insulating film was formed to obtain an insulated wire.

### Comparative Example 1

An insulated wire was obtained by following the same procedure as in Example 1 except for not forming the second insulating film.

### Comparative Example 2

NEOHEAT AI (insulating coating containing polyamide-imide resin, made by Totoku Toryo Co., Ltd.) was applied using a coating dice to a copper round wire (0.2 mmφ) without edges and then heated at 190° C. for 25 minutes. By repeating this cycle of applying the insulating coating and heat setting 3 times, an insulating film was formed to obtain an insulated wire.

[Evaluation]

The insulated wires obtained in Example 1 and Comparative Examples 1 and 2 were evaluated on a dielectric breakdown voltage using a withstand voltage insulation tester (Model 8525 manufactured by Tsuruga Electric Co.) by the metal foil method according to JIS C 3003. The results are shown in Table 1.

TABLE 1

| | Dielectric breakdown |
|---|---|
| | voltage (kV) |
| Example 1 | 8.0 |
| Example 2 | 4.7 |
| Comparative Example 1 | 4.4 |

As shown in Table 1, the insulated wire obtained in Example 1 had a higher dielectric breakdown voltage as compared with insulated wires obtained in Comparative Examples 1 and 2.

### Production Example 3

Production of an Acrylic Resin 1 Having an Epoxy Group

Butyl cellosolve (120 parts) was put in a reaction container and heated under stirring at 120° C. A mixed solution of 2 parts of tert-butylperoxy-2-ethylhexanoate and 10 parts of butyl cellosolve, and a monomer mixture consisting of 40 parts of glycidyl methacrylate, 150 parts of 2-ethylhexylmethacrylate, 50 parts of 2-hydroxyethyl methacrylate and 65 parts of n-butyl methacrylate were added dropwise thereto over 3 hours. This mixture was aged for 30 minutes and, then, a mixed solution of 0.5 part of tert-butylperoxy-2-ethylhexanoate and 5 parts of butyl cellosolve was added dropwise thereto over 30 minutes. Further, the resulting mixture was aged for 2 hours to obtain the solution of an acrylic resin 1 having an epoxy group with a non-volatile content of 42%. The number-average molecular weight, measured by gel permeation chromatography (GPC) in terms of polystyrene, of this acrylic resin 1 having an epoxy group was 11000.

### Production Example 4

Production of an Ammonium Quaternizing Agent 1

Isophorone diisocyanate (220 parts), 40 parts of methyl isobutyl ketone and 0.22 part of dibutyltin dilaurate were put in a reaction container, and 135 parts of 2-ethylhexanol was added dropwise thereto at 55° C. Thereafter, the mixture was reacted at 60° C. for 1 hour to obtain a half-blocked isocyanate solution. This solution was further heated to 80° C. and a mixed solution of 90 parts of N,N-dimethylaminoethanol and 10 parts of methyl isobutyl ketone was added dropwise thereto over 30 minutes. After recognizing that an isocyanate group disappeared using infrared spectrum analysis, the mixed solution was cooled to room temperature to obtain tertiary amine having a blocked isocyanate group. This solution was neutralized by adding 180 parts of a 50% aqueous solution of lactic acid to obtain a solution of an ammonium quaternizing agent 1.

### Production Example 5

Production of an Ammonium Quaternizing Agent 2

A solution of an ammonium quaternizing agent 2 was obtained by following the same procedure as in Production Example 4 except for using 160 parts of triethylene glycol monomethyl ether in place of 135 parts of 2-ethylhexanol used as a block agent and changing the amount of methyl isobutyl ketone as a solvent from 40 parts to 25 parts.

### Production Example 6

Production of an Acrylic Resin 1 Having an Ammonium Group

120 parts of butyl cellosolve was put in a reaction container and heated under stirring at 120° C. A mixed solution of 2 parts of tert-butylperoxy-2-ethylhexanoate and 10 parts of butyl cellosolve, and a monomer mixture, consisting of 15 parts of glycidyl methacrylate, 50 parts of 2-ethylhexyl methacrylate, 40 parts of 2-hydroxyethyl methacrylate and 15 parts of n-butyl methacrylate were added thereto in a dropwise manner over 3 hours. This mixture was aged for 30 minutes and, then, a mixed solution of 0.5 part of tert-butylperoxy-2-ethylhexanoate and 5 parts of butyl cellosolve was added thereto in a dropwise manner over 30 minutes. The resulting mixture was further aged for 2 hours and cooled. This acrylic resin 2 having an epoxy group had the number-average molecular weight of 12000 and the weight-average molecular weight of 28000, measured by GPC. By adding 7 parts of N,N-dimethylaminoethanol and 15 parts of a 50% aqueous solution of lactic acid to this acrylic resin 2 and heating under stirring at 80° C., the acrylic resin 2 was quaternized. Heating was stopped at the time when an acid value reached 1 or less and a viscosity rise stopped to obtain the solution of an acrylic resin having an ammonium group 1 with a nonvolatile content of 30%. The number of ammonium groups per one molecule of this acrylic resin 1 having an ammonium group was 6.0.

### Production Example 7

Production of an Acrylic Resin 2 Having an Ammonium Group

By adding 100 parts of the solution of the ammonium quaternizing agent 1 produced in Production Example 4 to 240 parts of the acrylic resin 1 having an epoxy group produced in Production Example 3 and heating under stirring at 80° C., the mixture was quaternized. Heating was stopped at the point in time when an acid value reached 1 or less and a viscosity rise was not recognized to obtain the solution of an acrylic resin 2 having an ammonium group with a non-volatile content of 39%. The number of ammonium groups per a molecule of this acrylic resin 2 having an ammonium group was 8.5.

### Production Example 8

Production of an Acrylic Resin 3 Having an Ammonium Group

The solution of an acrylic resin 3 having an ammonium group with a non-volatile content of 36% was obtained by following the same procedure as in Production Example 7 except for using 80 parts of the solution of the ammonium quaternizing agent 2 produced in Production Example 5 in place of 100 parts of the solution of the ammonium quaternizing agent 1. The number of ammonium groups per a molecule of this acrylic resin 3 having an ammonium group was 4.0.

### Production Example 9

Production of a Crosslinked Resin Particle 1

In a reaction container, 20 parts of the acrylic resin 1 having an ammonium group, produced in Production Examples 6, and 270 parts of ion-exchanged water were put, and the mixture was heated under stirring at 75° C. An aqueous solution of 1.5 parts of 2,2′-azobis(2-(2-imidazoline-2-yl)propane) neutralized wholly with acetic acid was added dropwise thereto over 5 minutes. The mixed solution was aged for 5 minutes and, then, 30 parts of methyl methacrylate was added dropwise thereto over 5 minutes. The mixture was further aged for 5 minutes, and preemulsion, which was obtained by adding an α,β-ethylenically unsaturated monomer mixture consisting of 170 parts of methyl methacrylate, 40 parts of styrene, 30 parts of n-butyl methacrylate, 5 parts of glycidyl methacrylate and 30 parts of neopentyl glycol dimethacrylate to a mixed solution of 70 parts of the acrylic resin 1 having an ammonium group and 250 parts of ion-exchanged water under stirring, was added dropwise thereto over 40 minutes. This mixture was aged for 60 minutes and, then, cooled to obtain a dispersion of a crosslinked resin particle 1. The resulting aqueous dispersion of the crosslinked resin particle 1 had a non-volatile content of 35%, a pH of 5.0 and a volume-average particle diameter of 100 nm. The aqueous dispersion of the crosslinked resin particle 1 was mixed with xylene to form a mixture and xylene was substituted for water being a solvent of the mixture while the mixture was azeotropically distilled in an evaporator to obtain a dispersion of a crosslinked resin particle 1 in xylene.

### Production Example 10

Production of a Crosslinked Resin Particle 2

In a reaction container, 20 parts of the acrylic resin 2 having an ammonium group, produced in Production Examples 7, and 300 parts of ion-exchanged water were put, and the mixture was heated under stirring at 75° C. An aqueous solution of 1 part of 2,2′-azobis(2-(2-imidazoline-2-yl)propane) neutralized wholly with acetic acid was added dropwise thereto over 5 minutes. The mixed solution was aged for 5 minutes and, then, 25 parts of methyl methacrylate was added dropwise thereto over 5 minutes. The mixture was further aged for 5 minutes and, then, preemulsion, which was obtained by adding an α,α-ethylenically unsaturated monomer mixture consisting of 140 parts of methyl methacrylate, 30 parts of styrene, 25 parts of n-butyl methacrylate, 5 parts of glycidyl methacrylate and 25 parts of neopentyl glycol dimethacrylate to a mixed solution of 55 parts of the acrylic resin 2 having an ammonium group and 270 parts of ion-exchanged water under stirring, was added dropwise thereto over 40 minutes. This mixture was aged for 60 minutes and, then, cooled to obtain a dispersion of a crosslinked resin particle 2. The resulting aqueous dispersion of the crosslinked resin particle 2 had a non-volatile content of 30%, a pH of 5.5 and a volume-average particle diameter of 100 nm. The aqueous dispersion of the crosslinked resin particle 2 was mixed with xylene to form a mixture and xylene was substituted for water being a solvent of the mixture while the mixture was azeotropically distilled in an evaporator to obtain a dispersion of a crosslinked resin particle 2 in xylene.

### Production Example 11

Production of a Crosslinked Resin Particle 3

An aqueous dispersion of a crosslinked resin particle 3 was obtained by following the same procedure as in Production Example 10 except that in place of the acrylic resin 2 having an ammonium group used as an emulsifier, the same amount of the acrylic resin 3 having an ammonium group was used. The resulting aqueous dispersion of the crosslinked resin particle 3 had a non-volatile content of 30%, a pH of 5.5 and a volume-average particle diameter of 90 nm. The aqueous dispersion of the crosslinked resin particle 3 was mixed with xylene to form a mixture and xylene was substituted for water being a solvent of the mixture while the mixture was azeotropically distilled in an evaporator to obtain a dispersion of a crosslinked resin particle 3 in xylene.

### Production Example 12

Production of a Crosslinked Resin Particle 4

An aqueous dispersion of a crosslinked resin particle 4 was obtained by following the same procedure as in Production Example 10 except for changing the amount of neopentyl glycol dimethacrylate in the α,β-ethylenically unsaturated monomer mixture from 25 parts to 40 parts. The resulting aqueous dispersion of the crosslinked resin particle 4 had a non-volatile content of 30%, a pH of 5.0 and a volume-average particle diameter of 150 nm. This aqueous dispersion was mixed with xylene to form a mixture and xylene was substituted for water being a solvent of the mixture while the mixture was azeotropically distilled in an evaporator to obtain a dispersion of a crosslinked resin particle 4 in xylene.

### Production Example 13

Production of a Crosslinked Resin Particle 5 Using an Emulsifier Other than an Acrylic Resin Having an ammonium Group

Hexadecyltrimethylammonium chloride (7 parts) was put in a reaction container as an emulsifier and dissolved in 300 parts of ion-exchanged water, and the dissolved solution was heated under stirring at 75° C. An aqueous solution of 1 part of 2,2′-azobis(2-(2-imidazoline-2-yl)propane) neutralized wholly with acetic acid was added dropwise thereto over 5 minutes. The mixed solution was aged for 5 minutes and, then, 10 parts of methyl methacrylate was added dropwise thereto over 5 minutes. The mixture was further aged for 5 minutes, and preemulsion, which was obtained by adding an α,β-ethylenically unsaturated monomer mixture consisting of 140 parts of methyl methacrylate, 30 parts of styrene, 25 parts of n-butyl methacrylate, 5 parts of glycidyl methacrylate and 25 parts of neopentyl glycol dimethacrylate to a mixed solution of 22 parts of hexadecyltrimethylammonium chloride and 270 parts of ion-exchanged water under stirring, was added dropwise thereto over 40 minutes. This mixture was aged for 60 minutes and, then, cooled to obtain an aqueous dispersion of a crosslinked resin particle 5, which had a non-volatile content of 30%, a pH of 5.2 and a volume-average particle diameter of 120 nm. This aqueous dispersion was mixed with xylene to form a mixture and xylene was substituted for water being a solvent of the mixture while the mixture was azeotropically distilled in an evaporator to obtain a dispersion of a crosslinked resin particle 5 in xylene.

### Production Example 14

Production of a Non-Crosslinked Resin Particle

In a reaction container, 20 parts of the acrylic resin 1 having an ammonium group, produced in Production Examples 6, and 300 parts of ion-exchanged water were put, and the mixture was heated under stirring at 75° C. An aqueous solution of 1 part of 2,2′-azobis(2-(2-imidazoline-2-yl)propane) neutralized wholly with acetic acid was added dropwise thereto over 5 minutes. The mixed solution was aged for 5 minutes and, then, 10 parts of methyl methacrylate was added dropwise thereto over 5 minutes. The mixture was further aged for 5 minutes, and preemulsion, which was obtained by adding an α,β-ethylenically unsaturated monomer mixture containing no poly(meth)acrylate, consisting of 140 parts of methyl methacrylate, 30 parts of styrene, 25 parts of n-butyl methacrylate and 5 parts of glycidyl methacrylate, to an aqueous solution of 55 parts of the acrylic resin 1 having an ammonium group and 270 parts of ion-exchanged water under stirring, was added dropwise thereto over 40 minutes. This mixture was aged for 60 minutes and, then, cooled to obtain an aqueous dispersion of a non-crosslinked resin particle. The resulting aqueous dispersion of the non-crosslinked resin particle had a non-volatile content of 32.8%, a pH of 5.0 and a volume-average particle diameter of 106 nm. This aqueous dispersion was mixed with xylene to form a mixture and xylene was substituted for water being a solvent of the mixture while the mixture was azeotropically distilled in an evaporator to obtain a dispersion of a non-crosslinked resin particle in xylene.

### Production Example 15

Production of a Cationic Electrocoating

The resin composition obtained in Production Example 1 (142.9 parts) and 157.1 parts of deionized water were mixed and, to this mixture, the aqueous dispersion of the crosslinked resin particle 1 obtained in Production Example 9 was further added in such a manner that the solid matter content of the dispersion is 20% by weight relative to the resin solidmatter in the coating. After the mixture was stirred in a high-speed rotary mixer for 1 hour, this aqueous solution was adjusted so as to have a solid matter content of 15% by weight to obtain a cationic electrocoating.

### Production Examples 16 to 19

Production of a Cationic Electrocoating

Cationic electrocoatings were obtained by following the same procedure as in Production Example 15 except for using the aqueous dispersion of crosslinked resin particles 2 to 5 obtained in Production Examples 10 to 13 in place of the aqueous dispersion of the crosslinked resin particle 1 obtained in Production Example 9.

### Production Example 20

Production of an Insulating Coating

The dispersion of a crosslinked resin particle 1 in xylene obtained in Production Example 9 was added to NEOHEAT AI (polyamide-imide resin coating, made by Totoku Toryo Co., Ltd., resin solid matter in a coating composition: 40% by weight) in such a way that the amount of this dispersion is 20% by weight relative to the resin solid matter in the coating composition, and the mixture was stirred for 1 hour with a mixer. Thereafter, xylene was added to the mixture in such a way that the concentration of the solid matter is 15% by weight to obtain an insulating coating.

### Production Examples 21 to 24

Production of Insulating Coatings

Respective insulating coatings were obtained by following the same procedure as in Production Example 20 except for using the dispersions of crosslinked resin particles 2 to 5 in xylene obtained in Production Examples 10 to 13, respectively, in place of the dispersion of a crosslinked resin particle 1 in xylene obtained in Production Example 9.

### Production Example 25

Production of an Insulating Coating

An insulating coating was obtained by following the same procedure as in Production Example 20 except for using the dispersion of anon-crosslinked resin particle in xylene obtained in Production Example 14 in place of the dispersion of a crosslinked resin particle 1 in xylene obtained in Production Example 9.

### Production Example 26

Production of a Crosslinked Resin Particle 6

Into a separable flask provided with a dropping funnel, a thermometer, a nitrogen gas inlet tube, a reflux cooling tube and a stirrer were charged 289.6 parts of ion-exchanged water and 10.3 parts of a resin dilution solution prepared by diluting the epoxy resin composition produced in Production Example 1 until the solid matter content of the epoxy resin composition reaches 36.1%. The temperature of this mixture was raised to 70° C. under being stirred in a nitrogen atmosphere. An aqueous solution consisting of 20.0 parts of ion-exchanged water, 0.5 part of VA-061 (azo initiator produced by Wako Pure Chemical Industries, Ltd.) and 0.3 part of an 90% aqueous solution of acetic acid was added thereto dropwise over 5 minutes. To this mixture, a preemulsion, which was prepared by adding a monomer mixture consisting of 80 parts of styrene and 20 parts of divinylbenzene to an emulsifier solution formed by dissolving 20.5 parts of a resin dilution solution identical to the above one in 130 parts of ion-exchanged water and by emulsifying the resulting mixture with a mixer, was added dropwise from a dropping funnel constantly over 75 minutes. After the completion of the dropwise addition, the preemulsion mixture was aged at that temperature for 60 minutes and then cooled. With the addition of ion-exchanged water, a dispersion of a crosslinked resin particle 6, having a nonvolatile content of 20%, was obtained. The resulting dispersion of the crosslinked resin particle 6 had a pH of 4.8 and a volume-average particle diameter of 100 nm.

### Production Example 27

Production of a Cationic Electrocoating

A cationic electrocoating was obtained by following the same procedure as in Production Example 15 except for using the dispersion of the crosslinked resin particle 6 obtained in Production Example 26 in place of the dispersion of the crosslinked resin particle 1 obtained in Production Example 9 and preparing a coating in such a manner that a solid matter content was equivalent to that in Production Example 15.

### Production Example 28

Production of a Crosslinked Resin Particle 7

Into a separable flask provided with a dropping funnel, a thermometer, a nitrogen gas inlet tube, a reflux cooling tube and a stirrer were charged 289.0 parts of ion-exchanged water and 10.0 parts of AQUARON HS-10 (α-sulfo-ω)-[2-(1-propenyl)-4-nonyl-phenoxy]polyoxyethylene (n=10) ammonium salt, made by Daiichi Kogyo Seiyaku Co., Ltd.), and the temperature of this mixture was raised to 80° C. in a nitrogen atmosphere. Aside from this mixture, a preemulsion was prepared by adding a monomer mixture solution consisting of 13 parts of styrene, 42 parts of methyl methacrylate and 45 parts of ethylene glycol dimethacrylate to an emulsifier solution formed by dissolving 5.0 parts of AQUARON HS-10 in 134.5 parts of ion-exchanged water and by emulsifying the resulting mixture with a mixer. To the mixture described above, the preemulsion thus prepared and an initiator solution formed by dissolving 0.5 part of ammonium persulfate in 36.7 parts of ion-exchanged water were added dropwise simultaneously from two separate dropping funnels. The preemulsion was added constantly over 60 minutes and the initiator solution constantly over 75 minutes. After the completion of the dropwise addition, the resulting mixture was aged at that temperature for 60 minutes and then cooled. With the addition of ion-exchanged water, a dispersion of a crosslinked resin particle 7, having a nonvolatile content of 15%, was obtained. The resulting dispersion of the crosslinked resin particle 7 had a pH of 7.3 and a volume-average particle diameter of 80 nm.

### Production Example 29

Production of a Cationic Electrocoating

A cationic electrocoating was obtained by following the same procedure as in Production Example 15 except for using the dispersion of a crosslinked resin particle 7 obtained in Production Example 28 in place of the dispersion of a crosslinked resin particle 1 obtained in Production Example 9 and preparing a coating in such a manner that a solid content was equivalent to that in Production Example 15.

### Example 2

A first insulating film was formed on the surface of a rectangular copper wire having edges (a cross section profile being rectangular and having a size of 0.5 mm×0.1 mm, and the curvature being 10%) having a rectangular shape in the cross-sectional profile by subjecting the rectangular wire to the following pretreatment means, electrodeposition means, washing means and heating means.

[Pretreatment Means]

(1) The electric wire was degreased with SURF POWER (made by NIPPON PAINT Co., Ltd.) at a treatment temperature of 45° C. for a treatment time of 60 seconds.

(2) The degreased electric wire was washed with water by spraying for 30 seconds.

[Electrodeposition Means]

The wire after water washing was immersed in the cationic electrocoating obtained in Production Examples 15 stored as an electrocoating bath liquid in an electrocoating bath and cationic electrodeposited at a bath temperature of 30° C. for 5 seconds with a voltage of 100 V being applied (with the wire as the cathode and the counter electrode as the anode).

[Washing Means]

The wire obtained after immersion period of cationic electrodeposition was washed with water by spraying for 30 seconds to remove the cationic electrocoating adhering to the wire.

[Heating Means]

The wire after washing was heated in a hot air drying oven at 190° C. for 25 minutes to form an insulating film and give an insulated wire.

The resulting wire on which the first insulating film was formed was immersion-coated with the insulating coating obtained in Production Example 20, and then heated at 190° C. for 8 minutes. By repeating this cycle of applying the insulating coating and heat setting 3 times, the second insulating film was formed to obtain an insulated wire.

### Examples 3 to 18

Insulated wires were obtained by following the same procedure as in Example 2 except for using the cationic electrocoatings and insulating coatings shown in Table 2 in place of the cationic electrocoating obtained in Production Example 15 and the insulating coating obtained in Production Example 20.

### Example 19

An insulated wire was obtained by following the same procedure as in Example 2 except for using the cationic electrocoating obtained in Production Example 2 in place of the cationic electrocoating obtained in Production Example 15 and for using NEOHEAT AI in place of the insulating coating obtained in Production Example 20.

### Example 20

An insulated wire was obtained by following the same procedure as in Example 19 except for using the insulating coating obtained in Production Example 25 in place of NEOHEAT AI.

### Comparative Examples 3 and 4

An insulated wire was obtained by following the same procedure as in Comparative Examples 1 and 2 except for using the rectangular copper wire subjected to the pretreatment means used in Example 2 in place of the round wire.

[Evaluation]

Dielectric breakdown voltages of insulated wires obtained in Examples 2 to 20 were evaluated in the same manner as that of Example 1. The results are shown in Table 2.

TABLE 2

| | | Example | | | | | | | | | | |
|---|---|---|---|---|---|---|---|---|---|---|---|---|
| | | 2 | 3 | 4 | 5 | 6 | 7 | 8 | 9 | 10 | 11 | 12 |
| Cationic electrocoating | Production | 15 | 16 | 17 | 18 | 19 | 15 | 16 | 17 | 18 | 19 | 2 |
| | Example | | | | | | | | | | | |
| Crosslinked resin | Production | 9 | 10 | 11 | 12 | 13 | 9 | 10 | 11 | 12 | 13 | — |
| particle contained | Example | | | | | | | | | | | |
| Insulating coating | Production | 20 | 21 | 22 | 23 | 24 | NEO¹⁾ | NEO¹⁾ | NEO¹⁾ | NEO¹⁾ | NEO¹⁾ | 20 |
| | Example | | | | | | | | | | | |
| Crosslinked resin | Production | 9 | 10 | 11 | 12 | 13 | — | — | — | — | — | 9 |
| particle contained | Example | | | | | | | | | | | |

| | | | | | | | | | | | |
|---|---|---|---|---|---|---|---|---|---|---|---|
| Dielectric breakdown voltage (kV) | 8.0 | 7.4 | 8.2 | 7.8 | 7.6 | 5.2 • | 4.8 | 5.3 | 5.1 | 4.9 | 3.6 |

| | | Example | | | | | | | | Compar. Ex. | |
|---|---|---|---|---|---|---|---|---|---|---|---|
| | | 13 | 14 | 15 | 16 | 17 | 18 | 19 | 20 | 3 | 4 |
| Cationic electrocoating | Production | 2 | 2 | 2 | 2 | 27 | 29 | 2 | 2 | 2 | — |
| | Example | | | | | | | | | | |
| Crosslinked resin | Production | — | — | — | — | 26 | 28 | — | — | — | — |
| particle contained | Example | | | | | | | | | | |
| Insulating coating | Production | 21 | 22 | 23 | 24 | 22 | 22 | NEO¹⁾ | 25 | — | NEO¹⁾ |
| | Example | | | | | | | | | | |
| Crosslinked resin | Production | 10 | 11 | 12 | 13 | 11 | 11 | — | 14²⁾ | — | — |
| particle contained | Example | | | | | | | | | | |

| | | | | | | | | | | |
|---|---|---|---|---|---|---|---|---|---|---|
| Dielectric breakdown voltage (kV) | 3.8 | 3.7 | 3.5 | 3.4 | 8.5 | 7.4 | 0.5 | 0.9 | 0.3 | 0.3 |

¹⁾NEO means NEOHEAT A1 (polyamide-imide resin coating manufactured by TOTOKU TORYO Co., Ltd.)
²⁾In Production Example 14, a non-crosslinked resin particle is used.

As shown in Table 2, when the crosslinked resin particle was incorporated into the cationic electrocoating and/or the insulating coating, a higher dielectric breakdown voltage can be imparted also to an electric wire having edges than the case where the crosslinked resin particle is not incorporated. In particular, when the cationic electrocoating and the insulating coating containing crosslinked resin particles obtained by emulsion polymerization using a resin having an ammonium group or a sulfonium group as an emulsifier were used (Examples 2 to 18), a higher dielectric breakdown voltage was obtained.

### INDUSTRIAL APPLICABILITY

Since the method of coating an electric wire of the present invention has the above-mentioned constitution, this method is a method by which an insulated wire having a higher dielectric breakdown voltage can be obtained. Therefore, the present method can be preferably applied also to utilities requiring a higher dielectric breakdown voltage.

1. A method of coating an electric wire, comprising a step (I) of forming a first insulating film by cationic electrodeposition using a cationic electrocoating, and a step (II) of forming a second insulating film on the first insulating film formed in the step (I) using an insulating coating,
said cationic electrocoating containing a resin composition of which a hydratable functional group is reduced directly by an electron and passivated, resulting in deposition of a film.

2. The method of coating an electric wire according to claim 1,
wherein the resin composition has a sulfonium group and a propargyl group.

3. The method of coating an electric wire according to claim 1 or 2,
wherein the resin composition has a sulfonium group content of 5 to 400 milli moles, a propargyl group content of 10 to 495 milli moles and a total content of the sulfonium and propargyl groups of 500 milli moles or less, per 100 g of the solid matter in the resin composition.

4. The method of coating an electric wire according to claim 1 or 2,
wherein the resin composition has a sulfonium group content of 5 to 250 milli moles, a propargyl group content of 20 to 395 milli moles and a total content of the sulfonium and propargyl groups of 400 milli moles or less, per 100 g of the solid matter in the resin composition.

5. The method of coating an electric wire according to claim 1 or 2,
wherein the resin composition has an epoxy resin as a skeleton.

6. The method of coating an electric wire according to claim 5,
wherein the epoxy resin is a novolak cresol epoxy resin or a novolak phenol epoxy resin, and has a number-average molecular weight of 700 to 5000.

7. An insulated wire, which is obtained by method of coating an electric wire according to claim 1 or 2.

8. A method of coating an electric wire having edges comprising a step (I) of forming a first insulating film by cationic electrodeposition using a cationic electrocoating, and a step (II) of forming a second insulating film on the first insulating film formed in the step (I) using an insulating coating,
said cationic electrocoating containing a resin composition of which a hydratable functional group is reduced directly by an electron and passivated, resulting in deposition of a film and
said cationic electrocoating and/or the insulating coating containing crosslinked resin particles.

9. The method of coating an electric wire having edges according to claim 8,
wherein the cationic electrocoating contains crosslinked resin particles.

10. The method of coating an electric wire having edges according to claim 8 or 9,
the crosslinked resin particle being one of which a hydratable functional group is reduced directly by electrons and passivated.

11. The method of coating an electric wire having edges according to claim 8 or 9,
wherein the content of the crosslinked resin particles is 0.5 to 40% by weight in the coating.

12. The method of coating an electric wire having edges according to claim 8 or 9,
wherein the crosslinked resin particle is obtained by emulsion polymerizing an α,β-ethylenically unsaturated monomer mixture using a resin having an onium group as an emulsifier.

13. The method of coating an electric wire having edges according to claim 12,
wherein the resin having an onium group has 2 to 15 onium groups per one molecule.

14. The method of coating an electric wire having edges according to claim 12,
wherein the emulsifier is an acrylic resin or an epoxy resin.

15. The method of coating an electric wire having edges according to claim 12,
wherein the onium group is an ammonium group or a sulfonium group.

16. The method of coating an electric wire having edges according to claim 15,
wherein the acrylic resin or the epoxy resin, having the ammonium group or the sulfonium group, is obtained by adding a tertiary amine compound or sulfide and an organic acid to an acrylic resin or an epoxy resin, having an epoxy group, to convert the acrylic resin or the epoxy resin to a quaternary ammonium compound or a tertiary sulfonium compound.

17. The method of coating an electric wire having edges according to claim 16,
wherein a number-average molecular weight of the acrylic resin or the epoxy resin, having an epoxy group, is 2000 to 20000.

18. The method of coating an electric wire having edges according to claim 8 or 9,
wherein the resin composition has a sulfonium group and a propargyl group.

19. The method of coating an electric wire having edges according to claim 8 or 9,
wherein the resin composition has a sulfonium group content of 5 to 400 milli moles, a propargyl group content of 10 to 495 milli moles and a total content of the sulfonium and propargyl groups of 500 milli moles or less, per 100 g of the solid matter in the resin composition.

20. The method of coating an electric wire having edges according to claim 8 or 9,
wherein the resin composition includes an epoxy resin having a novolak cresol epoxy resin or a novolak phenol epoxy resin as a skeleton and having a number-average molecular weight of 700 to 5000, and
the resin composition also has a sulfonium group content of 5 to 250 milli moles, a propargyl group content of 20 to 395 milli moles and a total content of the sulfonium and propargyl groups of 400 milli moles or less, per 100 g of the solid matter in the resin composition.

21. An insulated wire, which is obtained by method of coating an electric wire having edges according to claim 8 or 9.
